(19) United States
(12) Patent Application Publication
(10) Pub. No.: US 2003/0061382 A1
(43) Pub. Date: Mar. 27, 2003

(54) System and method for naming hosts in a distributed data processing system

(75) Inventors: Michael E. Brown, Pflugerville, TX (US); Christopher A. Stanton, Austin, TX (US)

Correspondence Address: Michael R. Barre, Bakers Botts L.L.P., One Shell Plaza, 910 Louisiana, Houston, TX, 77002-4995, US

(73) Assignee: DELL PRODUCTS L.P.

(21) Appl. No.: 09/961,218

(22) Filed: Sep. 21, 2001

(51) Int. Cl. G06F 15/173; G06F 15/16

(52) U.S. Cl. 709/245; 709/226

(57) ABSTRACT

In a method for automatically naming hosts, a cluster controller receives unique identifiers (UIDs) from multiple hosts. In response to receiving the UIDs, the cluster controller causes the multiple hosts to produce ready signals. The cluster controller then receives user input (e.g., an indication that a floppy disk has been inserted into a floppy disk drive) from a first host among the multiple hosts. In response to receiving the user input from the first host, the cluster controller associates a first host name with the UID for the first host. The cluster controller then causes the first host to produce a completion signal. The cluster controller then receives user input from a second host among the multiple hosts. The operations of receiving replies from hosts, associating host names with UIDs, and causing hosts to produce completion signals may be repeated until each of the multiple hosts has been named.

### TECHNICAL FIELD

The present disclosure relates in general to systems and methods for configuring computer networks. In particular, the present disclosure relates to systems and methods for assigning names to hosts in distributed data processing systems.

### BACKGROUND

In distributed data processing systems (hereinafter “distributed systems”), two or more hosts are used to provide services for one or more specific applications. Each of the hosts in a typical distributed system will have a unique low-level network address, such as an Ethernet media access control (MAC) address. However, for many applications, it is necessary to assign a name to each of the hosts, as well. In addition to the host name and the low-level network address, many distributed system also use a high-level network address, such as an internet protocol (IP) address.

An example distributed system is a computer cluster, which typically includes numerous hosts and a cluster controller with a name server. The cluster controller and host systems each have a network interface, such as an Ethernet card, that provides a unique low-level network address, such as a MAC address. Each host may also have been configured to have a static IP address or to obtain a dynamic IP address upon connection to the network.

For example, there has been proposed a method of configuring IP addresses for a cluster, in which the individual who manages the configuration creates a set of address files that contain desired IP addresses. The individual also creates a name file for identifying which of the address files have already been used, if any. The address files and the name file are saved to a floppy disk. The individual then inserts the disk into the hosts in a desired sequence, with each host adopting the IP address in the first unused address file for itself and then updating the name file to indicate that the above address file has been used. After cycling the disk through all of the hosts, each host will have obtained a static IP address from a different address file. Alternatively, each host may update an index on the floppy disk to indicate which address files have been used.

When providing application services, however, distributed systems such as computer clusters typically use host names rather than network address. For instance, the users of a cluster and the application software usually refer to the hosts by name. The name server resolves the host names to host addresses for certain low-level software components. Configuring the cluster controller so that it associates the desired host names with the corresponding host addresses (i.e., host-name assignment) is therefore an important part of the process of configuring or reconfiguring the cluster.

In conventional networks, host names are generally selected and assigned manually, by an individual such as a network administrator. For example, when configuring a computer cluster, the network administrator is generally required to identify the MAC address for each host, select a name for each host, and create a list identifying the name, the MAC address, and a location for each host. The location is required because it may be important to be able to quickly locate a particular host, for example to replace a malfunctioning host.

A disadvantage associated with conventional processes for selecting and assigning host names, however, is that the network administrator's time and effort is required every time a new set of hosts is configured to form a network. Also, conventional processes are subject operator error. Manual host-naming processes therefore impose significant costs and risks of error in large distributed systems where hundreds or thousands of hosts must be named, and in dynamic distributed systems where hosts are frequently added, removed, or rearranged.

As recognized by the present invention, users would like to be able to configure and reconfigure distributed systems with minimal administrative overhead. For example, in an installation with hundreds of hosts subdivided into different clusters serving different applications, users may frequently want to move hosts between clusters, divide one cluster into two, combine two clusters into one, etc., based on changing application needs. According to conventional methods for naming hosts, significant time and effort is required every time the hardware configuration of the cluster needs to be changed. Moreover, it would be beneficial if end-users such as research scientists could effectively and efficiently configure and reconfigure clusters without assistance from network specialists such as network administrators. A need therefore exists for improved means for naming hosts in distributed systems.

### SUMMARY

The present disclosure relates to a method for automatically naming hosts in a distributed data processing system. According to that method, a cluster controller receives unique identifiers (UIDs) from multiple hosts. In response to receiving the UIDs, the cluster controller causes the hosts to produce ready signals (e.g., by activating LEDs on floppy disk drives for the hosts). The cluster controller then receives user input from a first host among the hosts. For example, the user input may be an indication that a floppy disk has been inserted into a floppy disk drive of the first host. In response to receiving the user input from the first host, the cluster controller associates a first host name with the UID for the first host. The cluster controller then causes the first host to produce a completion signal (e.g., by deactivating the LED).

The cluster controller then receives user input from a second host. The operations of receiving replies from hosts, associating host names with UIDs, and causing hosts to produce completion signals may be repeated until each of the multiple hosts has been named. Thus, the user input dictates the order in which the host names are assigned to the multiple hosts.

In an example embodiment, the operation of associating a first host name with the UID for the first host includes the operations of (i) transmitting data to the first host in response to the user input and (ii) thereafter receiving a reply from the first host. For example, the cluster controller may transmit the host-name index to the first host and receive an incremented host-name index from the first host in reply, with the host-name index being used to generate the host name for the first host. In such an embodiment, the first host name is associated with the UID for the first host in substantially direct response to the reply, although also indirectly in response to the original user input.

Accordingly, at least some embodiments of the present invention reduce the administrative overhead associated with naming hosts in a distributed system and allow distributed systems to be configured and reconfigured by personnel with relatively little networking expertise.

### BRIEF DESCRIPTION OF THE DRAWINGS

The present invention and its numerous objects, features, and advantages may be better understood by reference to the following description of an example embodiment and the accompanying drawings, in which:

FIG. 1 presents a high level block diagram of an example embodiment of a distributed computing system with support for automatic host naming;

FIGS. 2A-2C present an example data structure containing data for host-name assignment at various stages in a process for automatically assigning names to hosts;

FIGS. 3A-3C present an example table of host names at various stages in the process of automatically assigning names to hosts; and

FIG. 4 is a flowchart of an exemplary process for automatically assigning names to hosts.

### DETAILED DESCRIPTION OF AN EXAMPLE EMBODIMENT

FIG. 1 depicts a block diagram of an example distributed system 10 with facilities for automatically naming hosts according to the present invention. In the example embodiment, distributed system 10 includes a cluster controller 20 that is connected to multiple hosts 22 via one or more switches 14. Specifically, sixty-four hosts 22 are arranged in two racks 16A and 16B. Each rack has thirty-two slots, and each host 22 resides in one of those slot.

Cluster controller 20 and hosts 22 each include a processing core with at least one central processing unit (CPU), as well as data storage in communication with the processing core. The data storage is used to hold or encode data and computer instructions for automatically naming the hosts. The data storage may be implemented as one or more hardware components from technologies including random access memory (RAM), read-only memory (ROM), disk drives, other non-volatile memory components, or any other suitable technology. The computer instructions may also be referred to generally as a program product or specifically as auto-host-naming software. In alternative embodiments, some or all of the control logic for automatically assigned host names may be implemented in hardware.

Cluster controller 20 and hosts 22 each also include a network interface in communication with the processing core for communicating with other parts of the distributed system. Cluster controller 20 is also provided with hardware such as a keyboard and a display for user input and output. Each host 22 also includes an electronically-encoded unique identifier (UID), such as a media access control (MAC) address associated with the network interface, a serial number associated with a CPU, a service tag stored in ROM by the system manufacturer, or any other suitable UID.

In addition, each host 22 includes means for providing user output and means for receiving user input. In the example embodiment, for instance, each host 22 includes a floppy disk drive 24 with a light emitting diode (LED) 26, and LED 26 is activated or deactivate to provide visual user output. Each host 22 also includes a speaker 30 for providing audible user output. When a floppy disk is inserted into floppy disk drive 24, the fact that a disk has been inserted is treated as user input, without regard to whatever data, if any, is stored on the disk. In alternative embodiments, user input and output for the auto-host-naming process may be provided by other mechanisms. For example, the hosts may take control of existing front panel buttons, such as reset switches 28, for receiving user input. Alternatively, the hosts may use dedicated switches and/or dedicated LEDs (aside from reset switches 28 and floppy LEDs 26) for input and output.

Cluster controller 20 is used to configure distributed system 10 to enable hosts 22 to work together in processing data. As described in greater detail below with reference to FIG. 4, that configuration process includes operations for assigning a host name to each host 22, so that users and application software may refer to each host 22 by name.

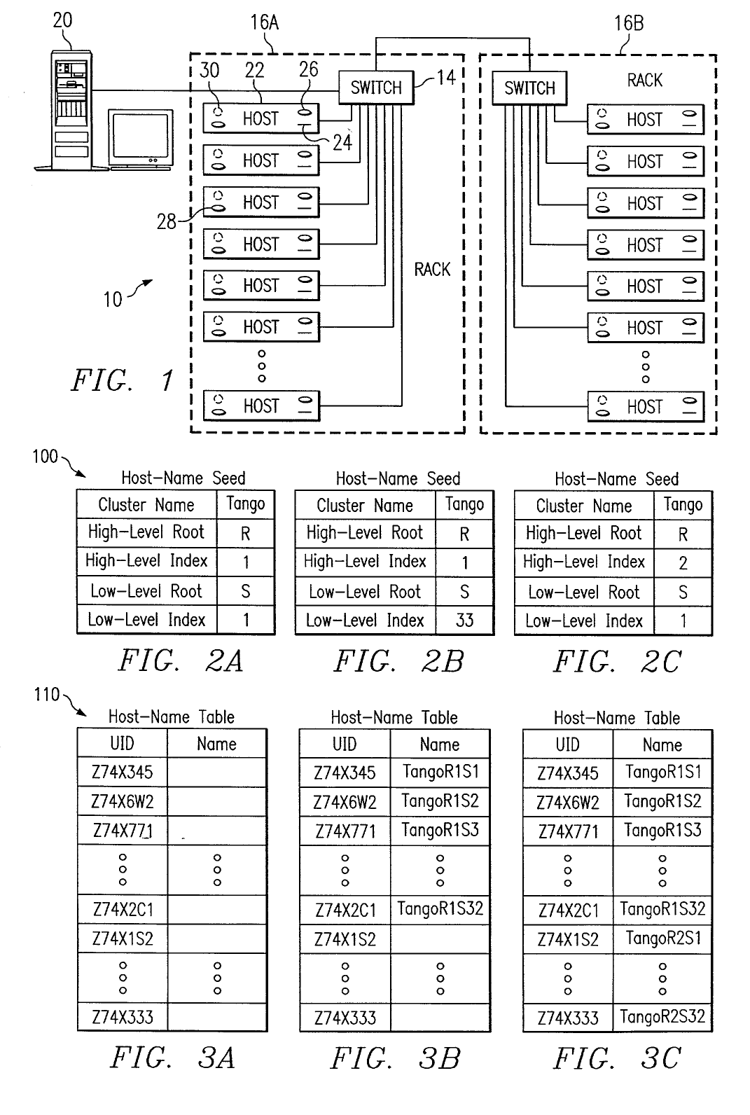

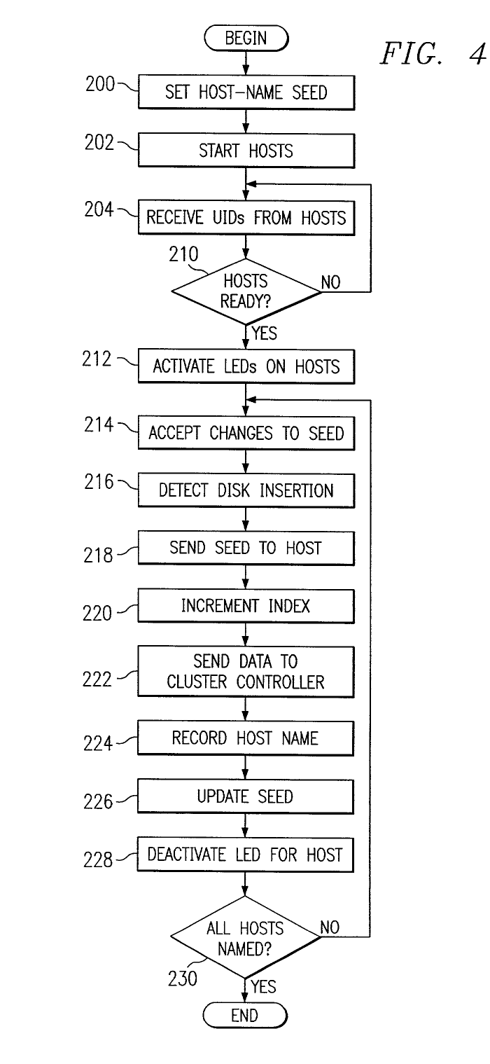

With reference now to FIG. 2A, there is depicted an example data structure 100 for use in naming hosts 22. Data structure 100, which resides in cluster controller 20, may be referred to as a host-name seed 100. As depicted in the rows of that data structure, host-name seed 100 contains values for a cluster name, a high-level root, a high-level index, a low-level root, and a low-level index. As depicted in FIG. 3A, cluster controller 20 also includes host-name table 110 for associating the UID of each host 22 with a host name.

Referring now to FIG. 4, an example process for automatically assigning names to hosts is presented. At the beginning of that process, the hardware for cluster 10 (i.e., cluster controller 20, hosts 22, etc.) has already been physically set up for intercommunication. For example, hosts 22 have been installed in racks 16A and 16B, and network cables have been installed between cluster controller 20, switches 14, and hosts 22, as necessary. Then, as depicted at block 200, the auto-host-naming software in cluster controller 20 allows an individual to initialize host-name seed 100. Specifically, as described below, the auto-host-naming software provides a host-naming process which can be operated by individuals with relatively little expertise in network administration. For instance, a typical research scientist could easily operate the auto-host-naming software. The individual who interacts with cluster controller 20 is therefore referred to as an operator rather than a network administrator. When setting host-name seed 100, the operator may for example specify a cluster name of “Tango,” a high-level root of “R” (for “rack”), a high-level index of 1, a low-level root of “S” (for slot”), and a low-level index of 1, as indicated in FIG. 2A.

As depicted by block 202, hosts 22 are then started (e.g., powered up). Hosts 22 also contain auto-host-naming software, and that software automatically causes each host 22 to send a UID to cluster controller 20. For instance, the auto-host-naming software in hosts 22 may be stored in ROM or obtained from cluster controller 20 upon startup, as described in greater detail below. As shown at block 204, when cluster controller 20 receives the UIDs from hosts 22, cluster controller 20 populates the UID column of host-name table 110 with those UIDs, as depicted in FIG. 3A. Cluster controller 20 then determines whether at least one host is ready to be named, as indicated at block 210. If cluster controller 20 determines that hosts 22 are not ready, for instance as a result of not having received any UIDs from hosts 22, the process returns to block 204 with cluster controller 20 waiting to receive the UIDs.

However, if hosts 22 are ready, cluster controller 20 causes hosts 22 to provide user output indicating that cluster 10 is ready to name hosts 22. Specifically, as indicated at block 212, the auto-host-naming software in cluster controller 20 activates LED 26 of floppy disk drive 24 for each host 22 that is ready. If desired, the operator may then modify host-name seed 100, as indicated at block 214.

The operator then selects which host 22 should receive the first name and, in response to seeing that the LED 26 for the selected host 22 has been activated, uses that host 22 to send user input to cluster controller 20. Specifically, the operator inserts a floppy disk into the floppy disk drive 24 for the selected host 22. In response to receiving the floppy disk, the auto-host-naming software in the selected host 22 sends a corresponding signal to cluster controller 20. As shown at blocks 216 and 218, upon detecting that a floppy disk has been inserted into one of hosts 22, cluster controller 20 sends the low-level index from host-name seed 100 to that host 22.

In response to receiving the low-level index, the auto-host-naming software in the selected host 22 increments the index and then returns the incremented index to cluster controller 20, as depicted at blocks 220 and 222. In response to receiving the incremented index, cluster controller 20 concatenates the parts of host-name seed 100 to form a host name, such as “TangoR1S1,” and associates that host name with the UID for the selected host 22. Specifically, the host name is stored in the row of host-name table 110 that contains the UID of the selected host 22. As shown at blocks 226 and 228, cluster controller 20 then updates host-name seed 100 with the incremented low-level index and causes the selected host 22 to provide the operator with a completion signal (e.g., by deactivating the LED 26 and sounding a tone on the speaker 30 of the selected host 22) to advise the operator that cluster controller 20 has finished assigning a host-name to that host 22.

It is then determined whether all of hosts 22 have been named, as indicated at block 230. If so, then the process of assigning host names ends. Otherwise, the process returns to block 214, with cluster controller 20 again allowing the operator to modify host-name seed 100.

In a typical naming run, the operator waits until the ready lights on all of hosts 22 are activated before inserting the floppy disk into the first host 22. Once all hosts 22 are ready, the operator inserts the disk into the host 22 at the top of rack 16A (i.e., into the host in rack 1, slot 1), waits for the light to be extinguished, removes the disk, inserts the disk into the next host down, waits for the light to be extinguished, etc., until the light has been extinguished for the host 22 at the bottom of rack 16A. As depicted in FIG. 3B, host-name table 100 will then contain host names for all thirty-two hosts 22 in rack 16A. Specifically, those hosts 32 will be named “TangoR1S1” through “TangoR1S32,” and the number that follows “S” will denote the physical slot that contains the corresponding host 22. Also, as depicted in FIG. 2B, host-name seed 100 will contain a high-level index of 1 and a low-level index of 33.

The operator then changes the high-level index to 2 and resets the low-level index to 1, as illustrated in FIG. 2C and as provided for at block 214 of FIG. 4. Consequently, when a disk is inserted into the top host 22 in rack 16B, cluster controller 20 will assign the name “TangoR2S1” to that host 22. The process will end once the thirty-two hosts 22 in rack 16B have been named, as indicated in FIG. 3C.

The auto-host-naming software may execute before any of hosts 22 have booted to an operating system (OS), and once hosts 22 are booted to an operating system, cluster controller 20 can provide the host names to the operating system in a process of completing preparatory operations in advance of application processing. For instance, hosts 22 may employ network-based booting, and the host naming process may include an initialization step in which cluster controller 20 loads auto-host-naming software onto each host 22, thereby equipping hosts 22 with the control logic necessary for sending UIDs to cluster controller 20 and otherwise interacting with cluster controller 20. The auto-host-naming software that is loaded into each host may also be referred to as holding-pattern software. For example, each host 22 may feature a set of pre-boot protocol services, such as the services provided by the INTEL preboot execution environment (PXE). The pre-boot protocol services may acquire the holding-pattern software when obtaining a boot image and configuration parameters from cluster controller 20.

In the example embodiment, the operator sets the auto-host-naming software in cluster controller 20 to activate auto-host naming when it is necessary to configure or reconfigure a cluster. At other times, cluster controller 20 is set to use the existing host names. Thus, once the host names for cluster 10 have been determined, subsequent booting of hosts 22 generally does not reactivate the host-naming process, but may instead activate a process of loading an OS and/or application software into each host and/or a process of loading the proper host name into the OS or application software. Alternatively, cluster controller 20 could load auto-host-naming software onto hosts that already have operational OSs.

In conclusion, as has been described, the example embodiment concerns a system and method for providing host names that clearly identify the physical location of each host, by cluster, rack, and slot. Furthermore, the method does not require specialized networking expertise. Moreover, the above method may be used to reconfigure existing clusters.

For example, if it became necessary to reassign a rack of thirty-two hosts from another cluster to the Tango cluster, the process of providing host names for each host in that expanded cluster would be the same as that described above, except that the third rack would be included and the operator would set the high-level index to 3 and the low level index to 1 after the last host in the second rack is named.

In the example embodiment, the index and incremented index are communicate between the cluster controller and each host. In an alternative embodiment, the data that the cluster controller sends to each host includes the entire host-name seed, and the data that each host returns to cluster controller includes the host name to be associated with that host, as well as the incremented index. In another alternative embodiment, the cluster controller does not communicate indexes with the hosts but simply assigns host names in the order in which it detects the user input (e.g., insertion of a floppy disk) from the hosts.

A benefit of the example embodiment is that the host names are assigned with no OS interaction. Since the hosts use holding-pattern software obtained via network booting, there is no need to have a fully functional OS present on the hosts, and the same auto-host-naming process may be used whether the hosts will be running UNIX, LINUX, WINDOWS NT, or any other OS when providing application services. The auto-host-naming process is thus platform agnostic. In alternative embodiments, the auto-host-naming process may nevertheless work with hosts having a running OS, if necessary. In addition, since the host names are stored in the cluster controller, if a host is replaced, or if the OS or software on a host is reloaded, the cluster controller 20 sets or resets the host name on the host to the proper value.

Although the present invention has been described with reference to an example embodiment and a small number of alternative embodiments, those with ordinary skill in the art will understand that numerous additional variations could be practiced without departing from the scope of the present invention. For example, it should be understood that, in alternative embodiments, the control logic for naming hosts may be implemented as hardware, software, or combinations of hardware and software.

Accordingly, the present invention is not limited to the specifically disclosed embodiments, but is defined by the following claims.

What is claimed is:

1. A method for automatically naming hosts in a distributed data processing system, the method comprising:
receiving unique identifiers (UIDS) from multiple hosts in communication with a cluster controller;
in response to receiving the UIDs, causing the multiple hosts to produce ready signals;
receiving user input from a first host among the multiple hosts;
in response to receiving the user input from the first host, associating a first host name with the UID for the first host;
after associating the first host name with the UID for the first host, causing the first host to produce a completion signal;
receiving user input from a second host among the multiple hosts; and
repeating the operations of receiving replies from hosts, associating host names with UIDs, and causing hosts to produce completion signals, until each of the multiple hosts has been named, such that the user input dictates the order in which host names are assigned to the multiple hosts.

2. The method of claim 1, wherein the operation of associating a first host name with the UID for the first host comprises:
in response to receiving the user input from the first host, transmitting data to the first host; and
after transmitting the data to the first host, receiving a reply from the first host, such that the first host name is associated with the UID for the first host in further response to the reply.

3. The method of claim 2, further comprising:
providing the cluster controller with a host-name index, wherein:
the operation of transmitting data to the first host comprises transmitting the host-name index to the first host;
the operation of receiving a reply from the first host comprises receiving an incremented host-name index from the first host; and
the operation of associating a host name with the UID for the first host comprises using the host-name index to generate the host name to be associated with the UID for the first host.

4. The method of claim 2, further comprising:
providing the cluster controller with a host-name index and a host-name root; and
providing the multiple hosts with auto-naming logic, wherein:
the auto-naming logic causes the multiple hosts to transmit the UIDs to the cluster controller;
the auto-naming logic receives the index in the data from the cluster controller, increments the index, and transmits the incremented index to the cluster controller in the reply; and
the operation of associating a host name with the UID for the first host comprises using the host-name root and the host-name index to generate the host name to be associated with the UID for the first host.

5. The method of claim 1, wherein the operation of causing the multiple hosts to produce ready signals comprises activating light emitting diodes (LEDs) on the multiple hosts to indicate that the multiple hosts are ready to be named.

6. The method of claim 1, wherein the operation of receiving user input from the first host comprises detecting that a disk has been inserted into a disk drive of the first host.

7. The method of claim 1, wherein the operation of causing the first host to produce a completion signal comprises deactivating a light emitting diode (LED) on the first host.

8. The method of claim 1, wherein the operation of causing the first host to produce a completion signal comprises producing an audible signal to indicate that the first host has been named.

9. A program product for automatically naming hosts in a distributed data processing system, the program product comprising:
computer instructions that:
receive unique identifiers (UIDs) from multiple hosts in communication with a cluster controller;
in response to receiving the UIDs, cause the multiple hosts to produce ready signals;
receive user input from a first host among the multiple hosts;
in response to receiving the user input from the first host, associate a first host name with the UID for the first host;
after associating the first host name with the UID for the first host, cause the first host to produce a completion signal;
receive user input from a second host among the multiple hosts; and
repeat the operations of receiving replies from hosts, associating host names with UIDs, and causing hosts to produce completion signals, until each of the multiple hosts has been named, such that the user input dictates the order in which host names are assigned to the multiple hosts; and
a computer-usable medium encoding the computer instructions.

10. The program product of claim 8, wherein:
the computer instructions respond to the user input from the first host by transmitting data to the first host;
the computer instructions receive a reply from the first host; and
the computer instructions associate the first host name with the UID for the first host in further response to the reply.

11. The program product of claim 10, wherein the operations performed by the computer instructions further comprise:
recognizing a host-name index; and
transmitting the host-name index to the first host with the data, wherein:
the operation of receiving a reply from the first host comprises receiving an incremented host-name index from the first host; and
the operation of associating a host name with the UID for the first host comprises using the host-name index to generate the host name to be associated with the UID for the first host.

12. The program product of claim 9, wherein the computer instructions cause the multiple hosts to produce ready signals by activating light emitting diodes (LEDs) on the multiple hosts to indicate that the multiple hosts are ready to be named.

13. The program product of claim 9, wherein the user input comprises signals indicating that a disk has been inserted into a disk drive of the first host.

14. The program product of claim 9, wherein the computer instructions cause the first host to produce a completion signal by deactivating a light emitting diode (LED) on the first host.

15. The program product of claim 9, wherein the computer instructions cause the first host to produce a completion signal by producing an audible signal to indicate that the first host has been named.

16. A data processing system for automatically naming hosts in a distributed data processing system, the data processing system comprising:
a network interface in communication with multiple hosts, a processor in communication with the network interface, data storage in communication with the processor, and computer instructions stored in the data storage, wherein, when the computer instructions are executed by the processing resources, the computer instructions perform operations comprising:
receiving unique identifiers (UIDs) from the multiple hosts;
in response to receiving the UIDs, causing the multiple hosts to produce ready signals;
receiving user input from a first host among the multiple hosts;
in response to receiving the user input from the first host, associating a first host name with the UID for the first host;
after associating the first host name with the UID for the first host, causing the first host to produce a completion signal;
receiving user input from a second host among the multiple hosts; and
repeating the operations of receiving replies from hosts, associating host names with UIDs, and causing hosts to produce completion signals, until each of the multiple hosts has been named, such that the user input dictates the order in which host names are assigned to the multiple hosts.

17. The data processing system of claim 16, wherein the operation of associating a first host name with the UID for the first host comprises:
transmitting data to the first host; and
receiving a reply from the first host, wherein the computer instructions associate the first host name with the UID for the first host in further response to the reply.

18. The data processing system of claim 17, wherein the operations performed by the computer instructions further comprise
recognizing a host-name index; and
transmitting the host-name index to the first host with the data, wherein:
the operation of receiving a reply from the first host comprises receiving an incremented host-name index from the first host; and
the operation of associating a host name with the UID for the first host comprises using the host-name index to generate the host name to be associated with the UID for the first host.

19. The data processing system of claim 16, wherein the computer instructions cause the multiple hosts to produce ready signals by activating light emitting diodes (LEDs) on the multiple hosts to indicate that the multiple hosts are ready to be named.

20. The data processing system of claim 16, wherein the user input comprises signals indicating that a disk has been inserted into a disk drive of the first host.

21. The data processing system of claim 16, wherein the computer instructions cause the first host to produce a completion signal by deactivating a light emitting diode (LED) on the first host.
